(19) United States
(12) Patent Application Publication
(10) Pub. No.: US 2025/0161963 A1
(43) Pub. Date: May 22, 2025

(54) ELECTROSTATIC COATING GUN

(71) Applicant: Carlisle Fluid Technologies, LLC, Scottsdale, AZ (US)

(72) Inventor: James Baltz, Perrysburg, OH (US)

(21) Appl. No.: 18/841,649

(22) PCT Filed: Feb. 22, 2023
(86) PCT No.: PCT/US2023/013833

§ 371 Date: Aug. 26, 2024

Related U.S. Application Data
(60) Provisional application No. 63/313,533, filed on Feb. 24, 2022.

(51) Int. Cl. B05B 5/053; B05B 12/00

(52) U.S. Cl. CPC B05B 5/0533; B05B 12/0026

(57) ABSTRACT

An electrostatic coating gun can include an air cap, fluid nozzle, a gun body, an air inlet, and a coating inlet, wherein the air cap comprises a removably attached electrode wire configured to conduct an electrostatic charge to a coating. The gun body comprises a handle, a trigger, and a trigger guard. The trigger guard comprises a base including a hinge, as well as a set of parallel extensions terminating in a set of parallel protrusions. The trigger guard is configured so that when the extensions are in frictional engagement with a first of a set of notches in the trigger guard base, the trigger can be prevented from being pulled toward the handle.

### CROSS-REFERENCE TO RELATED APPLICATIONS

This application is a national stage application of PCT/US2023/013833, filed 24 Feb. 2023, which claims priority to U.S. Provisional Application 63/313,553, filed 24 Feb. 2022, from which priority is claimed and are incorporated as if fully rewritten herein.

### BACKGROUND

This disclosure relates to an electrostatic coating gun, and specifically, to an electrostatic coating gun that can include a removable electrode and a trigger guard.

### SUMMARY

An electrostatic coating gun can include an air cap, fluid nozzle, a gun body, an air inlet, and a coating inlet, wherein the air cap comprises a removably attached electrode wire configured to conduct an electrostatic charge to a coating.

### BRIEF DESCRIPTION OF THE FIGURES

FIG. 1 is an example, non-limiting view of the embodiments disclosed herein.

FIG. 2 is an example, non-limiting view of the removable electrode described herein.

FIG. 3 is an example, non-limiting view of the trigger guard described herein.

### DETAILED DESCRIPTION

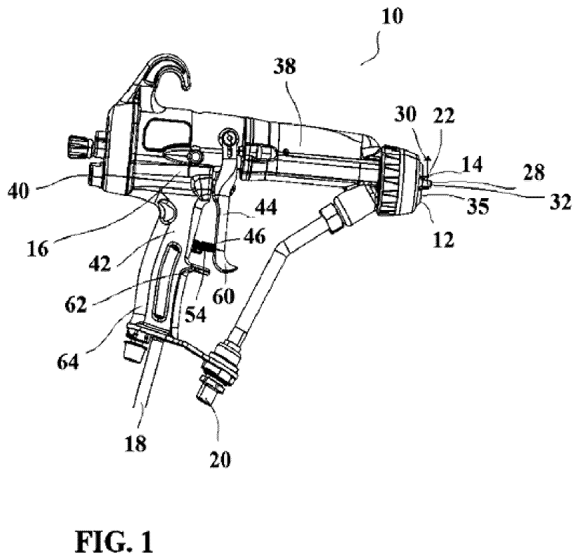

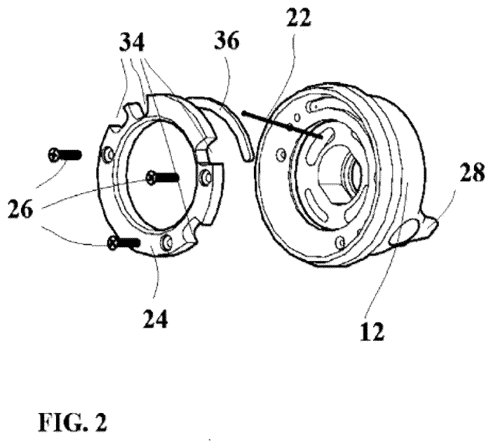

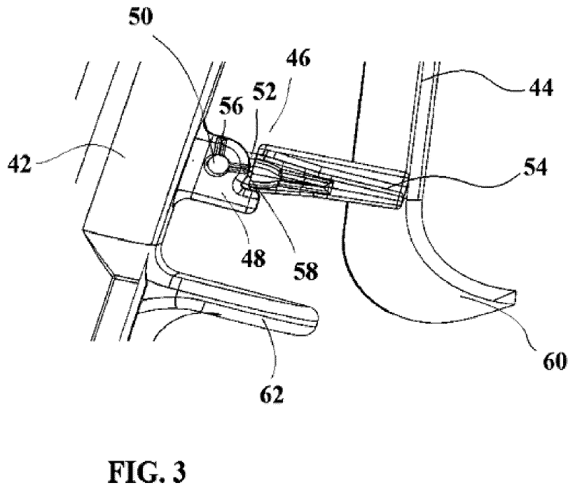

As shown in FIGS. 1-3, an electrostatic coating gun 10 can include an air cap 12, a fluid nozzle 14, a gun body 16, an air inlet 18, and a coating inlet 20, wherein the air cap 12 comprises a removably attached electrode wire 22 configured to conduct an electrostatic charge to a coating. The electrostatic coating gun 10 can charge a dispensed coating by an indirect charge, wherein the electrode wire 22 ionizes the area surrounding the outlet of the fluid nozzle 14 and a coating is charged by passing through the area in route to a grounded target. The coating can come from a coating source through the coating inlet 20, through a non-adjustable fluid control valve 40, and then through the fluid tip and toward the grounded target. In some embodiments, the removably attached electrode wire 22 is held to the air cap 12 by a retaining ring 24, wherein the retaining ring 24 is attached to the air cap 12 by a plurality of screws 26. The air cap 12 can include screw holes to receive the screws 26. The wire can be removed by removal of the air cap 12 and retaining ring 24 from the gun body 16, removal of the screws 26, and thereby simply pulling out the electrode wire 22. In use, the wire can extend from a face 35 of the air cap 12, wherein the face 35 is between a user and a target. According to certain embodiments, the plurality of screws 26 are equally radially spaced about the retaining ring 24 and air cap 12. In some embodiments, the retaining ring 24 is configured to selectively orient a set of shaping air outlets 28 on the air cap 12 in each of vertical position 30 or horizontal position 32. According to certain embodiments, the retaining ring 24 is configured to selectively orient a set of shaping air outlets 28 on the air cap 12 in a vertical or horizontal position by a friction fit of the air cap 12 within a plurality of notches 34 in the retaining ring 24. In some embodiments, the retaining ring 24 is configured to hold a conductive element 36 configured to receive electrical power and transfer the electrical power to the removably attached electrode. In some embodiments, the conductive element 36 is a semicircular element in direct electrical communication with the removably attached wire and a power cascade 38 (within gun body). According to certain embodiments, the electrostatic coating gun 10 comprises a non-adjustable fluid control valve 40. In some embodiments, gun body 16 comprises a handle 42, trigger 44, and a trigger guard 46. According to certain embodiments, the trigger guard 46 comprises a trigger guard base 48 comprising a hinge 50. According to some embodiments, the trigger guard 46 comprises a set of parallel extensions 52 attached to the hinge 50 and a set of parallel protrusions 54 attached to the extensions. According to some embodiments, the trigger guard base 48 comprises a set of first trigger guard notches 56 and a set of second trigger guard notches 58, wherein the parallel extensions 52 can form a friction fit with either of the first trigger guard notches 56 or second trigger guard notches 58. In some embodiments, the trigger guard 46 is configured to prevent actuation of the trigger 44 when the set of parallel extensions 52 are in a friction fit with the first trigger guard notches 56. In some embodiments, trigger guard 46 is configured to prevent actuation of the trigger 44 when the set of parallel extensions 52 are in a friction fit with the first trigger guard notches 56 by preventing a user from pulling the trigger 44 toward the handle 42 by blocking motion of a finger from a base portion 60 of the trigger 44 toward the handle 42. In some embodiments, the trigger guard 46 is configured to allow actuation of the trigger 44 when the set of parallel extension are in a friction fit with the second trigger guard notches 58, wherein the handle 42 comprises a finger shelf 62, wherein the finger shelf 62 prevents motion of the extensions toward the handle base 64, wherein the trigger guard base 48 comprises a flared portion for attachment to the handle 42, and wherein the trigger guard 46 consists of a polyamide resin consisting of the reaction product of the polymerization of monomers from the group consisting of caprolactam, hexamethylene diamine, adipic acid, and combinations thereof.

I claim:

1. An electrostatic coating gun, comprising: an air cap; a fluid nozzle; a gun body; an air inlet;
and a coating inlet, wherein the air cap comprises a removably attached electrode wire configured to conduct an electrostatic charge to a coating. by indirect charge, by extending slightly from a face of the air cap.

2. The electrostatic coating gun of claim 1, wherein the removably attached electrode wire is held to the air cap by a retaining ring, wherein the retaining ring is attached to the air cap by a plurality of screws.

3. The electrostatic coating gun of claim 2, wherein the plurality of screws are equally radially spaced about the retaining ring and air cap.

4. The electrostatic coating gun of claim 2, wherein the retaining ring is configured to selectively orient a set of shaping air outlets on the air cap in each of a vertical position or a horizontal position.

5. The electrostatic coating gun of claim 4, wherein the retaining ring is configured to selectively orient a set of shaping air outlets on the air cap in a vertical or horizonal position by a friction fit of the air cap within a plurality of notches in the retaining ring.

6. The electrostatic coating gun of claim 2, wherein the retaining ring is configured to hold a conductive element configured to receive electrical power and transfer the electrical power to the removably attached electrode wire.

7. The electrostatic coating gun of claim 4, wherein the conductive element is a semicircular element in direct electrical communication with the removably attached wire electrode and a power cascade.

8. The electrostatic coating gun of claim 2, wherein the electrostatic coating gun comprises a non-adjustable fluid control valve.

9. The electrostatic coating gun of claim 1, wherein the gun body comprises a handle, trigger, and a trigger guard.

10. The electrostatic coating gun of claim 9, wherein the trigger guard comprises a trigger guard base comprising a hinge.

11. The electrostatic coating gun of claim 10, wherein the trigger guard comprises a set of parallel extensions attached to the hinge and a set of parallel protrusions attached to the extensions.

12. The electrostatic coating gun of claim 11, wherein the trigger guard base comprises a set of first trigger guard notches and a set of second trigger guard notches, wherein the parallel extensions can form a friction fit with either of the first trigger guard notches or second trigger guard notches.

13. The electrostatic coating gun of claim 12, wherein the trigger guard is configured to prevent actuation of the trigger when the set of parallel extensions are in a friction fit with the first trigger guard notches.

14. The electrostatic coating gun of claim 13, wherein the trigger guard is configured to prevent actuation of the trigger when the set of parallel extensions are in a friction fit with the first trigger guard notches by preventing a user from pulling the trigger toward the handle by blocking motion of a finger from a base portion of the trigger toward the handle.

15. The electrostatic coating gun of claim 10, wherein the trigger guard is configured to allow actuation of the trigger when the set of parallel extension are in a friction fit with the second trigger guard notches, wherein the handle comprises a finger shelf, wherein the finger shelf prevents motion of the extensions toward the handle base, wherein the trigger guard base comprises a flared portion for attachment to the handle, and wherein the trigger guard consists of a polyamide resin consisting of the reaction product of the polymerization of monomers from the group consisting of caprolactam, hexamethylene diamine, adipic acid, and combinations thereof.
